(19) United States
(12) Patent Application Publication
(10) Pub. No.: US 2008/0294513 A1
(43) Pub. Date: Nov. 27, 2008

(54) METHOD OF TARGETED MARKETING

(76) Inventor: T. Joseph Buse, JR., Cleves, OH (US)

Correspondence Address: WOOD, HERRON & EVANS, LLP, 2700 CAREW TOWER, 441 VINE STREET, CINCINNATI, OH, 45202, US

(21) Appl. No.: 11/752,411

(22) Filed: May 23, 2007

(51) Int. Cl. G06Q 30/00; G06Q 40/00

(52) U.S. Cl. 705/14; 705/40

(57) ABSTRACT

A method for supplying a targeted message with a statement to a consumer. Consumer data is provided to generate a first statement item. The first statement item includes data used as predetermined triggers. Supplemental data is provided which is compared to the predetermined triggers thereby creating a first subset of supplemental data. The targeted message is created from the first subset of the supplemental data.

### FIELD OF THE INVENTION

The invention relates to providing one or more targeted messages to consumers and in particular, providing one or more targeted messages with a consumer statement.

### BACKGROUND OF THE INVENTION

Many businesses in a variety of industries provide each of their customers with a statement detailing the customer's charges/purchases over a period of time. For example, credit card issuers provide each of their account holders with a billing statement that lists each transaction, such as purchases and payments, which have been applied against their credit card account. Each transaction listed on the statement (each “statement item”) may specify a transaction amount, such as a purchase price debited to the account or a payment credited to the account. Statement items may also include merchant-specified text identifying the transaction, such as a merchant name, merchant address, and/or merchant telephone number. A statement may further include an amount due, which may be calculated by aggregating the transaction amounts.

Consumer statements may be used for advertising to account holders. Many merchants pay one or more credit card issuers for the ability to promote goods and services in flyers that are sent with credit card billing statements. For example, NewSub Services, Inc., a division of Synapse Group, Inc., is a merchant that advertises magazine subscriptions through attachments to credit card statements. In this manner, an account holder's billing statement can serve as a medium for advertising to that account holder. Similarly, statements created by companies in the airline industry may include messages or offers to earn additional frequent flyer miles or perhaps purchase trip insurance.

Consumer statements may also be used for notifying account holders of rewards they have earned. The American Express Custom Extras® program and Express Rewards® program each allow merchants to specify reward criteria. Account holders that meet the criteria are notified on their billing statement of what reward they may have earned.

Consumer statements thus serve to notify account holders of transaction history, merchant promotions, and rewards earned. At best, merchants hope that such notification may generate some future sales. However, like all advertising, the account holders may ignore the notification, and no future sales for the merchants are guaranteed.

In recent years, various systems have been used to distribute advisory and other information to pharmacy patients based principally on the identification of a prescription drug being purchased. Prescription drugs in the United States are uniquely identifiable by a National Drug Code (NDC). A pharmacist typically enters the NDC for a prescription drug into a computer terminal at the time of sale, or it may be encoded on the product itself in bar-code form. Other prescription drug identification systems are employed in other countries, but the principle is the same: to provide a unique code for each prescription drug dispensed by the pharmacy. A system for generating targeted messages to prescription drug consumers was developed by Catalina Marketing and disclosed in U.S. Pat. No. 6,240,394 which is incorporated by reference herein in its entirety. Based on the nature of the drug, a computer at the point of sale may be used to generate advisory messages to the patient, some of which may be required by governmental regulation. The computer may also be used to generate promotional materials concerning related or complementary products sold in the pharmacy.

Although such prior systems are satisfactory for some purposes, the advisory messages they provide are not always appropriately focused on the probable needs of the patients purchasing the drugs, medical or other services. What is needed therefore is a method of sending targeted, focused messages from an interested third party to a consumer that will have more relevance to the consumer than a generic advertisement or a general advisory message.

### SUMMARY OF THE INVENTION

The invention provides a method for automatically generating one or more targeted and related, promotional and/or consultative communications or messages to consumers based on predetermined triggers using existing apparatuses, which generate statements for a consumer. The messages, relative to the consumer, are intended to provide for an effective dialogue between the message sponsor and the consumer themselves. The invention encompasses first and third party services where statements are automatically generated for explanatory communication of collection or specific informative purposes.

The method generates targeted messages to consumers based on predetermined triggers when specific criteria are met. When a statement is processed, a computer including a database with rule engines may determine an appropriate message based on each trigger and attach the message for distribution, electronically or printed, accompanying with or on the statement to the consumer. The computer system may monitor the data using data capture software and/or hardware interposed between a transmitting party, a provider of goods or service, and the printer and/or exporting agent. An additional method of processing may compare selected targeted criteria of the transmitted data to target predetermined combinations of triggers in a functional database.

The computer system recognizes and associates the triggers with targeted messages and then retrieves from the database the matched message combinations to build a final targeted message for the communication for distribution, which may be the transmitting computer and/or an additional computer, server for e-mail, or printer, etc. Distribution or targeting of the messages may be based on selected combinations of the identified triggers being communicated to the consumer. Distribution may be implemented via e-mail, paper mail, or any other electronic or non-electronic mode of communication.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is an exemplary reproduction of a consumer statement.

FIG. 2 is a flowchart of an exemplary method for including one or more targeted messages with a statement to a consumer.

FIG. 3 is a schematic drawing of an exemplary embodiment of the method in FIG. 1 illustrating a healthcare example as applied to a patient of a medical/dental procedure.

FIG. 4 is an exemplary reproduction of a promotional message accompanying the consumer statement in FIG. 1.

### DETAILED DESCRIPTION

The invention provides a method for automatically generating one or more targeted and related, promotional and/or consultative communications or messages to consumers based on predetermined triggers using existing apparatuses in connection with statements, invoices, or explanations of benefits for a consumer regardless of the mode of communication. The apparatuses consist of traditional data entry means, computers for processing statements, and printers or other electronic servers to distribute the statements to consumers.

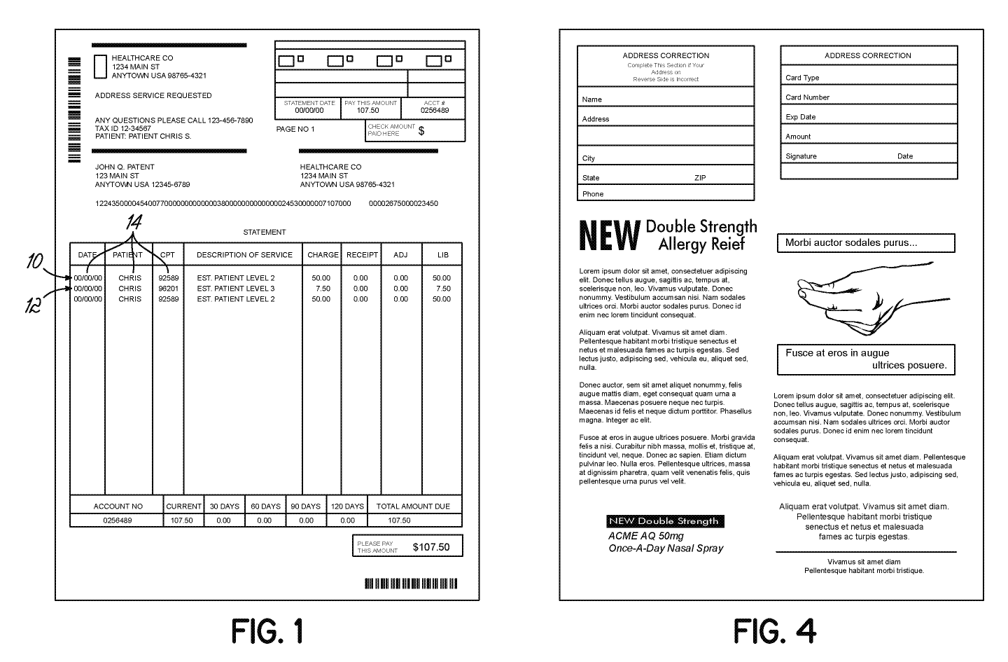

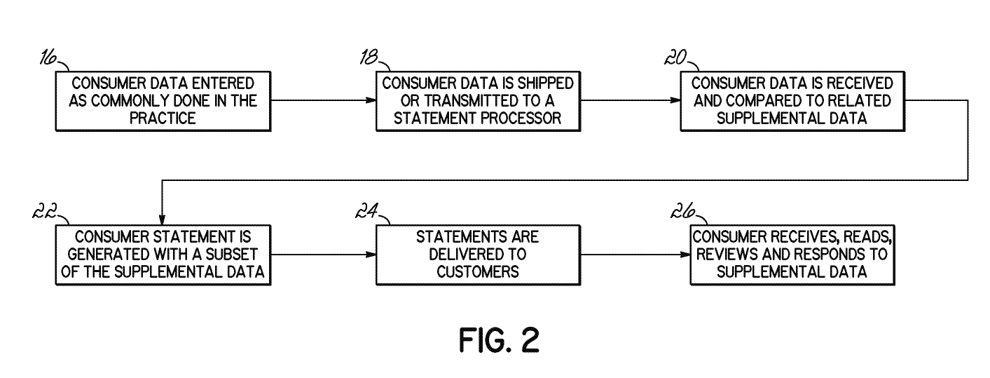

An exemplary representation of a consumer statement may be seen in FIG. 1. Consumer statements may generally be created from consumer data entered by a practitioner or a third party statement processor. Consumer statements may be composed of statement items 10, 12 as seen in FIG. 1. Components of the statement items 10, 12 may be used by the system and method as predetermined triggers 14 to generate targeted messages to the consumer. With continued reference to FIG. 1 and the flowchart in FIG. 2, in Block 16 consumer statement data consisting of at least a first statement item 10 is entered using generally known practices. Consumer statements may include invoices, statement of accounts, medical explanation of benefits, among others. In Block 18, the consumer data may then be either shipped or transmitted to a statement processor for processing. In Block 20, the consumer data is received and then compared to related supplemental data using the predetermined triggers 14, which may be provided to the statement processor by interested third parties.

Comparing the data may be performed by a rules engine, which may be decision logic based. The rules engine may compare the supplemental data with predetermined triggers 14 based on assigned criteria that would be established by the interested third party. Using the decision logic, the rules engine may select a subset of the supplemental data provided by the interested third parties based on the set of triggers 14, composed of specific components on the statement items 10, 12. The appropriate subset of the supplemental data may then be used to generate a targeted message to be included with the statement items 10, 12 on or with the statement. For example, triggers 14 may be medical diagnosis and/or procedure codes in the medical industry or volume usage in other industries like telecommunications or utilities.

The supplemental data may relate to promotional messages or consultative messages that pertain to the data on the statement. In Block 22, the statement items on the consumer statement are generated from the consumer data. Targeted messages are generated on or with the statement from the subset of the supplemental data. In one embodiment, the subset of the supplemental data may be printed as one or more targeted messages on either side, i.e. back or front, of the statement. In another embodiment, the subset of the supplemental data may be printed as one or more targeted messages on a separate sheet, which accompanies the statement when it is sent to the consumer. In yet another embodiment, the subset of the supplemental data may be included in an electronic statement available to the consumer. In Block 24, the consumer statements with their targeted messages are delivered to the consumers. In Block 26, the consumer receives the statement containing both the statement data and the targeted message or messages. The consumer may then read and review the information in the targeted message along with the statement and may respond to the information provided by the targeted message.

The method depicted in FIG. 2 may be utilized in any industry that generates a statement from data. In the banking industry, for example, some banks are more sophisticated in their analysis of customer data. They may look across multiple variables to build up an accurate profile of each customer, e.g. high net wealth customers. These banks may use loans, such as mortgages, as an indicator of wealth. They may then overlay the mortgage data with the corresponding customers addresses, to identify a likely socio-demographic make up of an area, for example, certain areas are predominantly occupied by wealth accumulators over 50 who have two or more children. While this type of analysis may be somewhat effective, it is not an area of expertise for banks.

Targeted advertising to prospective consumers delivers the best return on investment when ideal profiles are created. Marketing professionals use profiles to produce specific clusters of targeted consumers. There are many companies that provide sponsors with expertise, software, data and modeling solutions to meet this challenge, but typically once a profile is created, a separate source must be used to reach the consumer, thus creating potential errors and omissions.

However, statements for utilities, such as electric and gas, mortgage statements, credit card statements, such as from American Express, Visa, MasterCard, Discover, and others, offer a wealth of other information related to demographic variables, personal lifestyle preferences, buying patterns, and food purchases, among others. Each consumer may be demographically and behaviorally distinct thus providing for intense targetablitly. Combining this, through the method described above, would offer merchants such as the bank an opportunity to cross sell products such as credit cards, car loans, insurance, and wealth management with the existing statements produced.

Moreover, in recent years, the healthcare insurance industry, as well as others, has been providing consumers with remittance statements, known as Explanations of Benefits (EOB) forms. EOBs list the details of each claim, including but not limited to patients name, identification number, dates of service, deductibles, co-payments, coinsurance and services provided. The EOB details the amount billed, and paid for each claim, with an explanation of the benefits covered. EOB language is designed to be written in a clear and concise fashion to clearly communicate the benefits determination and payments made to beneficiaries and providers alike. Unfortunately, EOB language can create confusion between some patients and providers, which can interfere with the caregiver/patient relationship. EOBs may be delivered online; however, most are printed and mailed due to current regulatory requirements. Healthcare insurance companies, hospitals, and group medical practices, among others, face significant cost increases in processing EOB or remittance paperwork that accompanies payment from consumers.

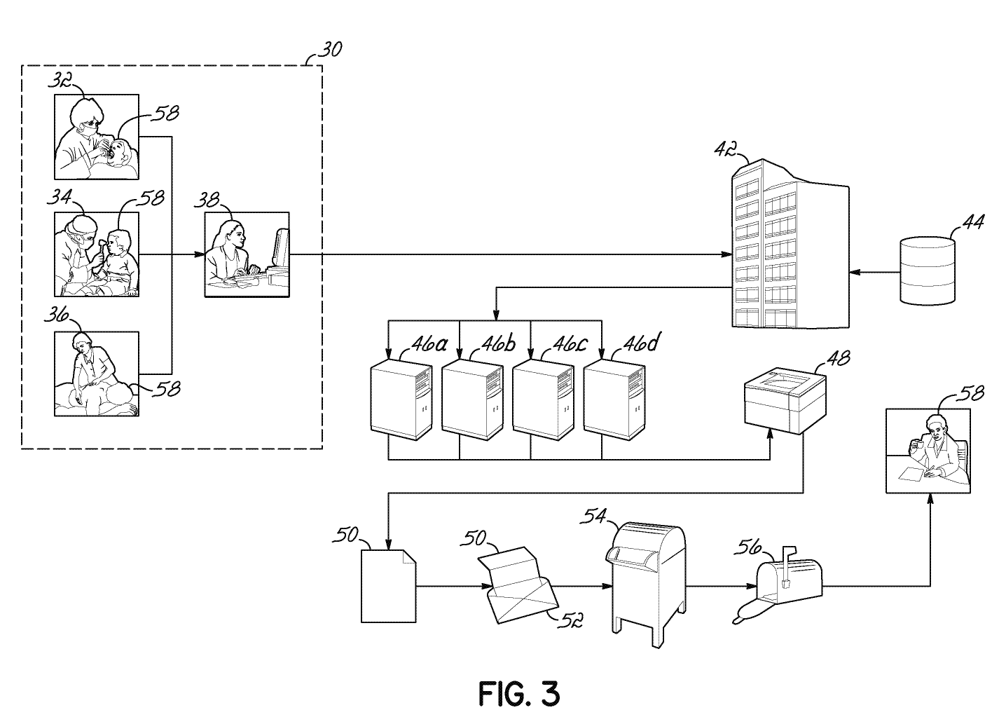

An application of the method of the invention to the healthcare industry may be seen in FIG. 3. As generally applied to this field, particularly medical, dental, or therapeutic, the method for automatically generating targeted, heath related, promotional and/or consultative communications, or messages to consumers may be based on medical diagnosis codes (ICD9), procedure codes (Current Procedural Terminology [CPT]), service (diagnosis and procedure) codes, or NDC codes. That is, the method recognizes and utilizes the diagnosis and/or procedure codes for a particular medical or dental patient as predetermined triggers, which, through the rules engine, are compared with related supplemental data that is retrieved from a database and combined to create a final targeted message or messages specific to that medical or dental patient. The targeted message is based on selected combinations of the identified medical diagnosis and/or procedure codes being invoiced to the patient, including, but not limited to, the patient's diagnosis, procedure, amount due, explanation of benefits/services, the party primarily responsible for disease state, medical provider, insurance company, payment, age, gender, date or frequency of visit and the patient's medical or dental history.

With reference now to FIG. 3, a medical or a dental patient 58 may visit an office 30 of a dentist 32, doctor 34, or therapist 36. In addition to making an office visit, the patient 58 may visit an urgent care facility, an outpatient center, a surgical center, or a hospital. After the treatment of the patient 58 has been completed in the office 30, as shown for this embodiment, a member of the office staff 38 may input the patient's medical or dental data into a computer as a number of individual items typically associated with an ICD9, CPT, or NDC code. In larger institutions such as an urgent care facility, outpatient center, surgical center, or hospital, the patient data may be sent to a processing department that is responsible for generating the patient statements. The patient statements may be generated directly at the office 30 or at the larger institutions. Alternatively, the data may be sent over network 40 to a company 42 specializing in the generation of medical statements. As providers are under regulatory, financial, and customer service/satisfaction pressures, many medical practices have decided to outsource their entire statement processing to third party statement processors to save time and money and improve regulatory compliance. These third party statement processors are mostly large, specialized businesses that produce and mail patient correspondence. Some of these third party statement processors may include Professional Office Service, Inc.®, GEMISYS, LASON™, MedStar®, Personix™, WebMD-Emdeon®, Per-Se Technologies®, Metropolitan Presort, Inc., and MISYS® Healthcare Systems, among others.

In some situations, such as with insurance companies, EOBs may be generated for the patients 58. Typically, when a patient 58 sees a health care provider, the provider will require services to be paid for up front, or the provider will file a claim on behalf of the patient 58. If the provider is filing on behalf of the patient 58, the patient 58 will sign an assignment of benefits form that is used by providers and insurance companies and authorizes an insurance company to send the payment directly to the provider rather than sending a check to the patient 58. The EOB form generated by the insurance company is sent to the patient 58 to notify that particular patient that payment has been made to his/her medical provider. Occasionally, depending on the status of the payment, more information may be provided, such as payment due or additional monies due from co-pays.

Where a third party statement processor is being utilized to generate statements, supplemental data may be supplied to the third party statement processor 42 through databases 44. These databases may be provided or populated by interested third parties, such as Professional Office Service (POS) as discussed above. The supplied supplemental data may contain meaningful information directly related to medical practices such as educational type materials for patients 58 related to the particular procedures associated with their statements. The supplied supplemental data may also contain a message or a coupon advertising medication, products, and/or services that are related to the medical procedure identified on the statement, or other supplemental information that may allow patients 58 to be more compliant with the instructions received from their health care provider. The supplemental data may also assist patients 58 in making new choices for therapy or improve their health outcomes. Computers 46a-46d, servers, or web based applications, at the third party statement processor 42 may take the information from the statements and compare the individual components of the statement items against the supplemental data in the databases 44.

A subset of the supplemental data is selected based on the statement items. In some embodiments, a rules engine may be used to compare predetermined triggers such as patient's diagnosis, procedure, amount due, explanation of benefits/services, the party primarily responsible for disease state, medical provider, insurance company, payment, age, gender, and date or frequency of visit, to the supplemental data. The supplemental data is then selected to generate the targeted messages based on assigned criteria that would be established by interested third parties, such as drug companies, medical study groups, rehabilitation service providers, among others. These messages are further refined as additional supplemental data is selected based on additional statement items. The targeted messages may then be generated electronically and/or printed by a printer 48 on either side of the medical statement 50. For other more complicated or lengthy targeted messages, the targeted message may be printed separately, and then may be included with the medical statement 50 sent to the patient 58.

The printed statements and the targeted messages may then be folded, put in envelopes 52 and placed in the mail 54 for delivery to the patient 58, which is the current common practice for the medical industry. Electronic versions of the statements and targeted messages may be sent to consumers via e-mail or may be available for inspection by the consumer online at a website. Alternatively, statements may be accessed by or sent to a cellular telephone, smart phone or personal data assistant (“PDA”). Upon delivery to the patient's home 56, the statements with the targeted messages may be retrieved and read by the patient 58. In addition to the patient 58 reviewing and reading the information on the statement, the patient 58 may also read and review the message generated from the supplemental information.

As discussed above, the message may be related to a promotion or may be a consultative message to the patient 58. In that regard, a targeted promotional message, shown in FIG. 4, may be printed on the back of the exemplary consumer statement illustrated in FIG. 1. In this example, the promotional message may be for an allergy medication that was generated based on the ICD9 code found on the consumer statement. That particular ICD9 code relates to a visit to the physician's office regarding allergies. Other messages may include coupon offers from a pharmacy for a patient 58 who uses that same pharmacy to fill his or her prescriptions. Additionally, informational or consultative messages may include information to the patient 58 directing them to a study for a particular procedure or for a particular condition that may be identified on the explanation of benefits statement via an ICD9 or CPT code. For example, a therapy patient 58 may be directed to a website that has additional information that corresponds to the therapy regimen that he or she is currently implementing. Any type of information that is related to these procedures may be generated and sent in connection with a statement or explanation of benefits to the patient 58. For statements not relating to the medical industry, the targeted messages may be generated based on promotional codes for other types of information. For example, a statement from a credit card company may include a targeted message related to similar purchases based on the buying habits of a particular consumer.

The method provides a vehicle for sending targeted, focused messages from an interested party to a consumer that has more relevance to the consumer than a generic advertisement or a general advisory message. Consequently, the consumer is more likely to read the targeted message and follow up with the interested party.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described.

What is claimed is:

1. A method for supplying a targeted message with a statement to a consumer, the method comprising:
providing consumer data;
generating a first statement item from the consumer data, the first statement item including predetermined triggers;
providing supplemental data;
comparing the predetermined triggers to the supplemental data thereby creating a first subset of supplemental data; and
creating the targeted message from the first subset of the supplemental data, wherein the targeted message is specific to the consumer.

2. The method of claim 1 further comprising:
distributing the targeted message with the statement to the consumer, wherein the statement is an account statement, a credit card statement, a billing statement, an explanation of benefits statement, or an account rewards statement, or combinations thereof.

3. The method of claim 2 wherein the targeted message is on the statement to the consumer.

4. The method of claim 2 wherein the targeted message and the statement are distributed electronically to the consumer.

5. The method of claim 4 wherein the targeted message and the statement are distributed via electronic mail to the consumer.

6. The method of claim 4 wherein the targeted message and the statement are distributed to the consumer via a website.

7. The method of claim 4 wherein the targeted message and the statement are distributed to a cellular phone, smart phone, or PDA.

8. The method of claim 1 wherein predetermined triggers are medical diagnosis codes, medical procedure codes, volume usage, demographic variables, personal lifestyle preferences, buying patterns, or food purchases, or combinations thereof.

9. The method of claim 1 wherein the comparing step uses a decision logic based rules engine.

10. A method for supplying a targeted message with a statement to a patient, the method comprising:
providing patient data;
generating a first statement item from the patient data, the first statement item including predetermined triggers, wherein predetermined triggers are medical diagnosis codes (ICD9), medical procedure codes (CPT), National Drug Codes (NDC), amount due, explanation of benefits/services, the party primarily responsible for disease state, medical provider, insurance company, payment, age, gender, date or frequency of visit, or combinations thereof;
providing supplemental data;
comparing the predetermined triggers to the supplemental data thereby creating a first subset of supplemental data; and
creating the targeted message from the first subset of the supplemental data, wherein the targeted message is specific to the patient.

11. The method of claim 10 wherein providing patient data further comprises:
transmitting the patient data to a third party statement processor.

12. The method of claim 10 wherein the predetermined triggers further include patient medical history.

13. The method of claim 10 wherein the comparing step uses a decision logic based rules engine.

14. The method of claim 10 further comprising:
distributing the targeted message with the statement to the consumer, wherein the statement is an account statement, a billing statement, or an explanation of benefits statement, or combinations thereof.

15. The method of claim 14 wherein the targeted message is on the statement to the consumer.

16. The method of claim 14 wherein the targeted message and the statement are distributed electronically to the consumer.

17. The method of claim 16 wherein the targeted message and the statement are distributed via electronic mail to the consumer.

18. The method of claim 16 wherein the targeted message and the statement are distributed to the consumer via a website.

19. The method of claim 16 wherein the targeted message and the statement are distributed to a cellular phone, smart phone, or PDA.

20. The method of claim 10 further comprising:
generating a second statement item from the patient data, the second statement item including predetermined triggers, wherein predetermined triggers are medical diagnosis codes (ICD9), medical procedure codes (CPT), National Drug Codes (NDC), amount due, explanation of benefits/services, the party primarily responsible for disease state, medical provider, insurance company, payment, age, gender, date or frequency of visit, or combinations thereof;
comparing the predetermined triggers in the second statement item to the supplemental data thereby creating a second subset of the supplemental data; and
refining the targeted message created from the first subset of the supplemental data with the second subset of the supplemental data.
